(19) United States
(12) Patent Application Publication
(10) Pub. No.: US 2006/0022419 A1
(43) Pub. Date: Feb. 2, 2006

(54) Modular laundry cart having collapsible basket

(76) Inventor: Sterling W. Phillips II, Newport Beach, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/901,635

(22) Filed: Jul. 29, 2004

(51) Int. Cl. B62B 3/00

(52) U.S. Cl. 280/47.35; 280/79.3

(57) ABSTRACT

A laundry cart including a basket that can be broken down into individual components, assembled and disassembled for shipment is disclosed. The individual components can be packaged economically with a relatively low profile. The laundry cart further has modular and interchangeable front and rear panels that may alternatively have a straight or a curved top cross-bar. An upper hanger assembly of the invention, as well as a lower shelf assembly, may also be broken down into individual components for shipping.

### BACKGROUND OF THE INVENTION

1. Field of the Invention

The present invention pertains generally to the shipping of baskets. More particularly, the present invention pertains to a laundry cart that is fully collapsible for boxing and shipping. The present invention is particularly, but not exclusively, useful as a laundry cart and method of assembly and shipping thereof, the laundry cart having modular components that can be broken down to a low profile package.

2. Description of the Prior Art

The use of laundry carts for generally handling clothes and transferring clothes from a washer to a dryer, and so forth, are known in the prior art. FIG. 1 illustrates a typical prior art example of a laundry cart 10 for use in public laundry facilities. The cart 10 generally has a wire basket 12 made of grated wire material wherein the basket is structurally one piece. The basket 12 is further attached to a base portion 14 having wheels 15 attached thereto, for transporting clothes. An upper hanger assembly 16 is also known that is used, as an example, for hanging clothes with clothes hangers.

Although the laundry cart 10 is generally suitable for its intended purposes, current methods of shipping the laundry cart have inefficiencies. Basket 12 is detachable from its base 14 portion and hanger assembly and can be removed and reassembled from the laundry cart 10. Typically, the basket 12 is shipped in one large box and the base 14, hanger assembly 16 and other hardware are shipped in a different box of different dimensions. FIG. 2 illustrates a prior art box 18 for shipping basket 12. Exemplary dimensions for prior art box 18 are 31″×27″×22,″ where 31″×27″ is a length times a width of a base portion and 22″ is the height h₁ of the prior art box 18. It would require four boxes to shop two laundry carts, six boxes to ship three laundry carts, and so on. A problem arises in the shipping rate charges in that packages are generally more economical with more densely packaged items and with multiple boxes. The nature of shipping laundry carts provides that the volume or height of the package is much more constraining economically than the weight of the package. More particularly, if a box is able to be “shipped flat,” then oversize charges will not be applicable. Accordingly, height h₁ that also corresponds to a height of the basket 12 is particularly constraining on the volume and shipping charges of the box 18. Therefore, a need exists to provide a laundry cart design and basket design that can be assembled and disassembled to fit in a relatively low volume box having a relatively low profile.

Further in light of the above, it is an object of the present invention to provide a laundry cart including a basket that can be broken down into individual components, assembled and disassembled for shipment. It is an additional object of the present invention to provide a laundry cart designed for shipping that can be shipped in one package instead of separate packages. It is further an object of the present invention to provide a laundry cart including a basket design wherein the individual components can be packaged economically with a relatively low profile. It is yet a further object of the present invention to provide a laundry cart having a basket that has modular and interchangeable front and rear panels that may alternatively have a straight or a curved top cross-bar. It is an additional object of the present invention to provide an upper hanger assembly for a laundry cart, as well as a lower shelf assembly, that may also be broken down into individual components for shipping.

### BRIEF SUMMARY OF THE INVENTION

While the apparatus and method has or will be described for the sake of grammatical fluidity with functional explanations, it is to be expressly understood that the claims, unless expressly formulated under 35 USC § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112. The invention can be better visualized by turning now to the following drawings wherein like elements are referenced by like numerals.

The present invention provides a laundry cart having a generally rectangular basket comprising: left and right grated side panels; a grated front panel removably secured the left and right grated side panels; a grated rear panel removably secured the left and right grated side panels; and a grated bottom panel removably secured to the grated front and rear panels, wherein the laundry cart can be assembled and disassembled for shipping.

The laundry cart, in a preferred embodiment, is further characterized in that the grated front and/or rear panel includes a top cross-bar, the top cross-bar optionally curved or straight, the curved or straight front and/or rear panel top cross-bars being modular and interchangeable with respect to one another and previous and subsequent components fabricated in manufacturing. In the example where the cross-bar is curved, it has a shape suitable for juxtaposition to a laundry dryer. The laundry cart further includes a plurality of pivotable wheels and a lower shelf assembly.

The present invention is also characterized as a generally rectangular basket comprising: left and right grated side panels each having lateral sides supported by front and rear stanchion bars; a grated front panel having top and bottom cross-bars each removably secured the front left and right lateral side stanchion bars; a grated rear panel having top and bottom cross-bars each removably secured the rear left and right lateral side stanchion bars; and a grated bottom panel having a first bottom support bar removably secured to the front and rear bottom cross-bars, wherein the rectangular basket can be assembled and disassembled for shipping.

The generally rectangular basket is further characterized wherein the grated bottom panel further comprises a second bottom support bar removably secured to the front and rear panel bottom cross-bars.

The lower shelf assembly, in a preferred embodiment of the present invention, is generally underneath the basket, and comprises: a front horizontal cross-bar removably connected the front left and right lateral side stanchion bars; a rear horizontal cross-bar, removably connected the rear left and right lateral side stanchion bars; a left lateral cross-bar, removably connected to the left front and left rear lateral side stanchion bars; and a right lateral cross-bar, removably connected to the right front and right rear lateral side stanchion bars; and a grated shelf supported by the front and rear horizontal cross-bars and the left and right lateral cross-bars.

The invention further comprises an upper hanger assembly that includes: left and right posts removably secured to the left and right grated side panels, the left and right posts having removable upper and lower portions; an arch assembly forming a highest horizontal cross-bar; a lower horizontal cross-bar removably connected to the upper portion of the left and right posts.

The present invention is also a method of packaging a basket, the method comprising: providing left and right grated side panels; providing a grated front panel; providing a grated rear panel; providing a grated bottom panel; stacking the left and right grated side panels, the grated front and rear panels and the grated bottom panel; and economically packaging the left and right grated side panels, the grated front and rear panels and grated bottom panel to provide a relatively low package profile.

The method of packaging a basket of the invention is further characterized wherein the basket is configured to be a laundry cart, the method further comprising: providing a plurality of wheels; and economically packaging the plurality of wheels with the left and right grated side panels, the grated front and rear panels and grated bottom panel to provide a relatively low profile package. Further according to the method, the low profile package has a volume and a density, and wherein low package profile is configured so that the volume is relatively low and the density is relatively high to economically package and ship the basket.

The method of packaging a basket of the present invention is further characterized wherein the basket is configured to be a laundry cart, and the method further comprises: providing an upper hanger assembly wherein the upper hanger assembly is comprised of individual components; and economically packaging the upper hanger assembly with the left and right grated side panels, and with the grated front and rear panels and grated bottom panel to provide a relatively low package profile.

The method of packaging a basket additionally comprises: providing a lower shelf assembly comprised of individual components; and economically packaging the a lower shelf assembly with the left and right grated side panels, and also with the grated front and rear panels and grated bottom panel to provide a relatively low package profile.

The present invention is additionally a method of assembling a laundry cart having a basket comprising: providing left and right grated side panels; removably securing a grated front panel to the left and right grated side panels; removably securing a grated rear panel to the left and right grated side panels; and removably securing a bottom panel to the grated front and rear panels, wherein the laundry cart is able to be disassembled for shipping. This method of assembling a laundry cart further comprises removably securing a plurality of pivotable wheels to the laundry cart; and removably securing a lower shelf assembly underneath the basket.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a prior art illustration of a typical laundry cart;

FIG. 2 is a prior art illustration of a box for shipping a prior art basket;

FIG. 3 is a perspective view of a preferred embodiment of a laundry cart according to the present invention;

FIG. 4 is a front elevational view of the preferred laundry cart of FIG. 3;

FIG. 5 is a side elevational view of the preferred laundry cart of FIG. 4;

FIG. 6 is a perspective illustration of another preferred embodiment of the present invention showing modular interchangeable basket front and rear panels;

FIG. 7 is a perspective illustration of yet another preferred embodiment of the present invention showing modular interchangeable basket front and rear panels;

FIG. 8 is a perspective illustration of an exemplary package used to ship a laundry cart according to the present invention; and

FIGS. 9A through 9C are illustrations of individual components being packaged successively in the box illustrated in FIG. 8.

### DETAILED DESCRIPTION OF THE PREFERRED EMBODIMENTS

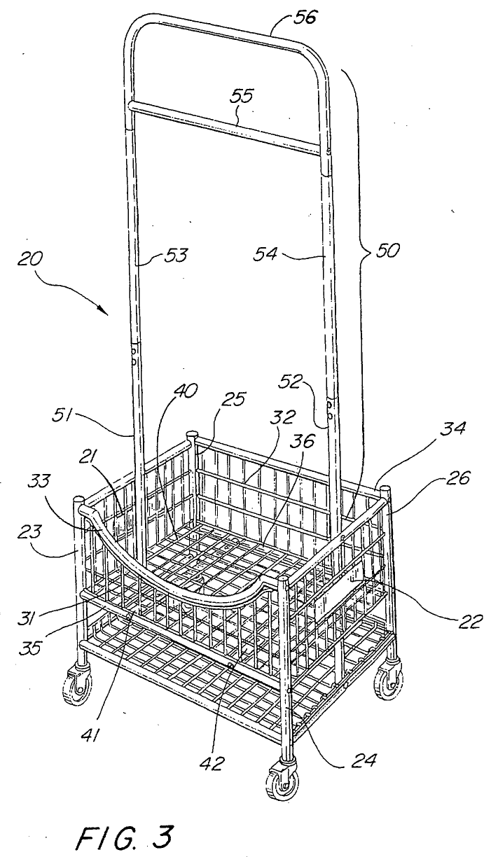

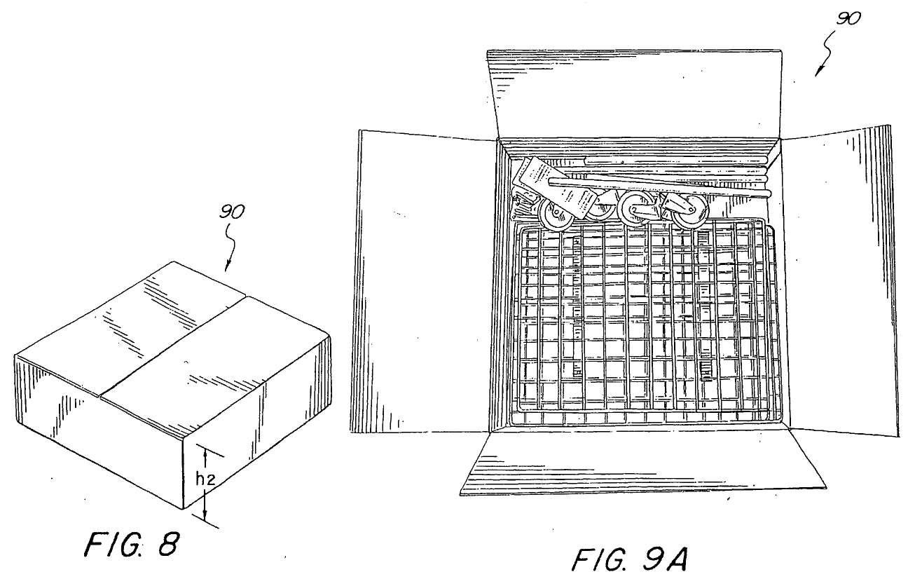

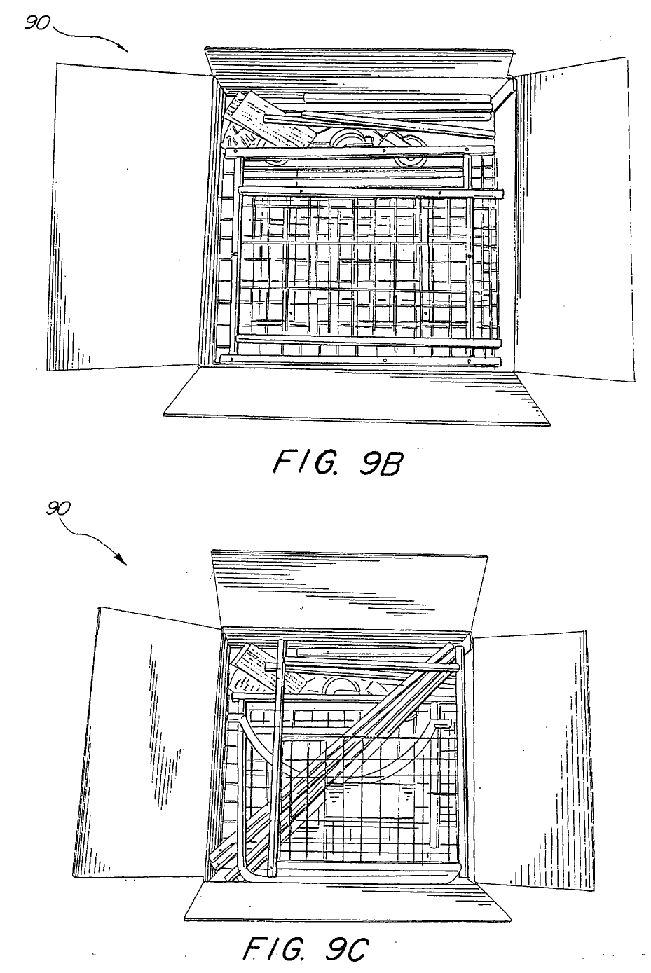

Referring initially to FIG. 3, a perspective view of a preferred embodiment of a laundry cart according to the present invention, is shown and is generally designated 20. A basket portion is generally enclosed on four sides with grated metal material, or the like, and has a bottom panel 40. The four sides are, in this example, left and right side panels 22, 21, and front and rear panels 31, 32. According to the invention, the entire laundry cart 20 can be broken down into individual components that can lie or be packaged in a relatively flat single package (as in FIGS. 8 through 9C).

The laundry cart basket is generally rectangular and the left and right side panels 22, 21, in a preferred embodiment, are manufactured with front and rear stanchion bars 23, 24, 25, 26 on their lateral sides. The front and rear stanchion bars 23, 24, 25, 26 are removably fastened to the front and rear panels 31, 32, respectively. It is to be appreciated that the front and rear stanchion bars 23, 24, 25, 26 could be manufactured fixed to the front and rear panels 31, 32; and the left and right side panels 22, 21 could, in a similar way, be removably attached to the front and rear panels 31, 32 having the stanchion bars. The stanchion bars 23, 24, 25, 26 are more specifically secured to front and rear panel 31, 32 top and bottom cross-bars 33, 34, 35, 36, in the embodiment shown in FIG. 3.

Further referring to FIG. 3, bottom panel 40 is secured to the basket portion via, in the preferred embodiment, first and second support bars 41, 42. Additionally, first and second support bars 41, 42 may be removably secured to bottom panel 40. Upper hanger assembly 50 is also provided that can be fully assembled and disassembled for low profile packaging (FIGS. 8 through 9C), according to the invention.

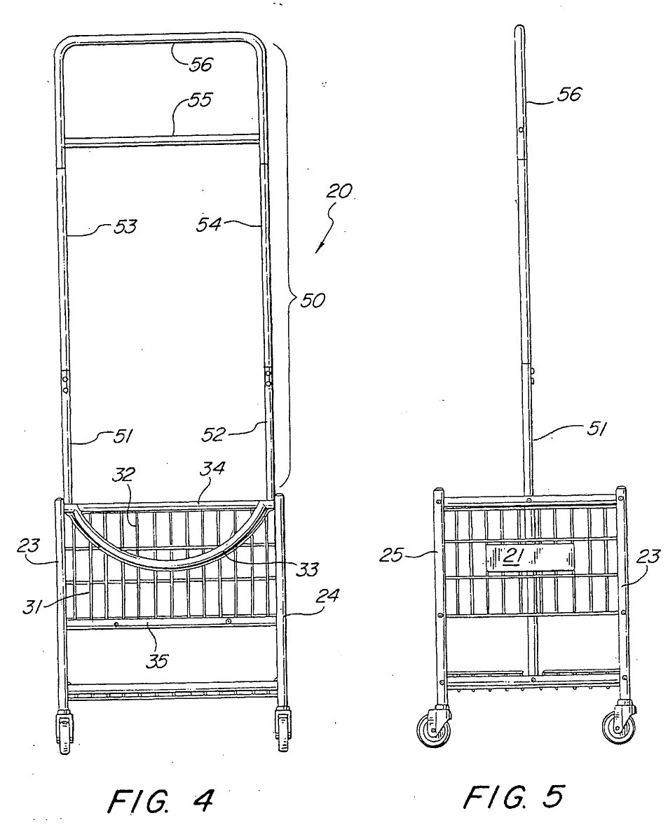

Referring to FIGS. 4 and 5, front and side elevational views of laundry cart 20, respectively, are illustrated. Upper hanger assembly 50 comprises left and right posts 52, 51 removably secured to the left and right grated side panels 22, 21. Further, the left and right posts have removable upper 54, 53 and lower 52, 51 portions. An arch assembly removably attached to the upper posts 53, 54 has a lower horizontal cross-bar 55 and a highest horizontal cross-bar 56.

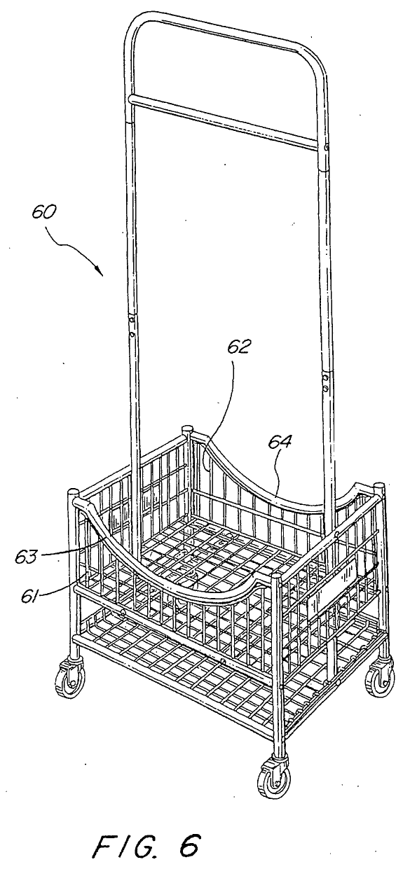

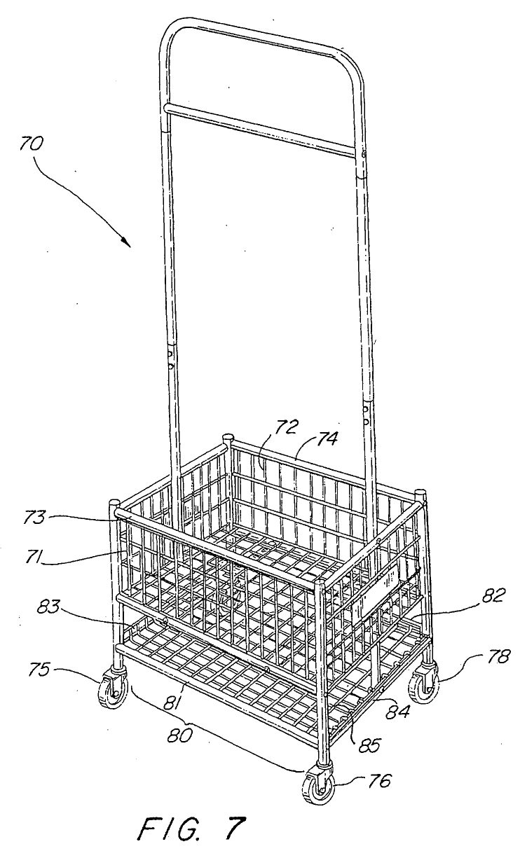

FIG. 6 is an additional preferred embodiment of the present invention, displaying modular and interchangeable front 61 and rear 62 panels. Top cross-bars 63, 64 are curved so that they can be juxtaposed to a dryer for transferring clothes, for example. FIG. 7 illustrates another embodiment of the present invention, further illustrating modular front 71 and rear panels 72, however having straight top cross-bars 73, and 74. Front and rear panels 61, 62, 71, 72 are modular and interchangeable with respect to each other and previous and subsequent components fabricated in manufacturing for economic efficiency. A lower shelf assembly 80 is optional in a preferred embodiment. The lower shelf assembly 80 comprises a front horizontal cross-bar 85, removably connected the front right and left lateral side stanchion bars 23, 24. Further included is a rear horizontal cross-bar 82, removably connected the rear right and left lateral side stanchion bars 25, 26. Also included are a left lateral cross-bar 84, removably connected to the left front 24 and left rear lateral side stanchion bars 24; and a right lateral cross-bar 83, removably connected to the right front 23 and right rear 25 lateral side stanchion bars; and a grated shelf 81 supported by the front 81 and rear 82 horizontal cross-bars and the left 84 and right 83 lateral cross-bars.

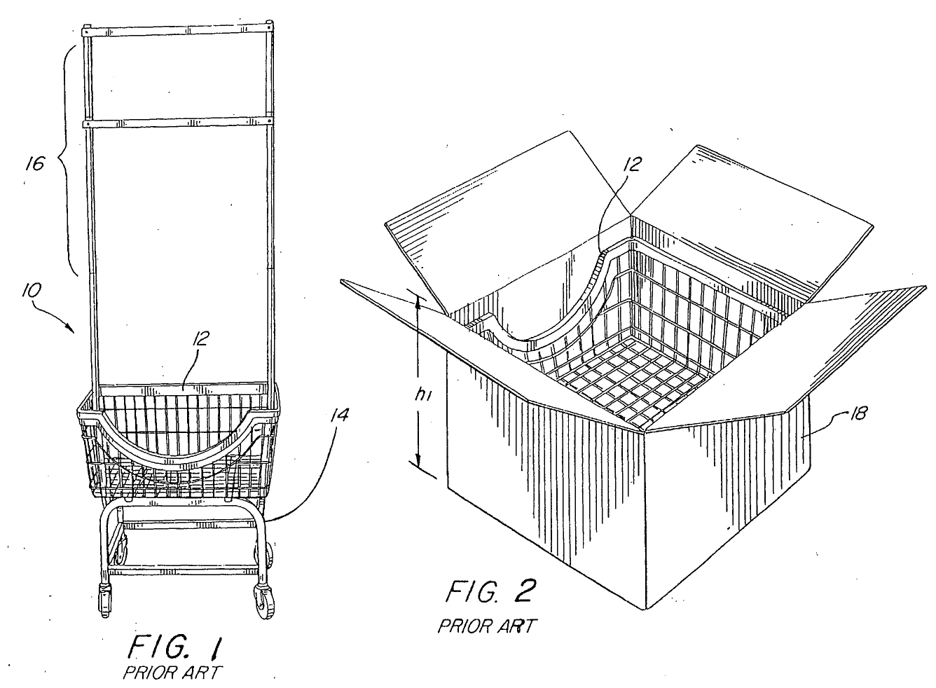

FIG. 8 illustrates a relatively low profile box 90, according to the invention for shipping, a disassembled laundry cart 20. Generally in shipping charges, items that are more densely packaged are more economically shipped. A generally flat, rectangular, densely packed box 90, would be ideal for example. Height h₂ provides a relatively low profile and is an important dimension for providing a relatively low volume box. Exemplary dimensions for box 90 are approximately 28″×28″×8,″ wherein 28″×28″ represents a length times a width, and 8″ is height h₂. This is a significant improvement over the prior art exemplary dimensions of 31″×27″×22,″ as shown in FIG. 2. In a particular embodiment, box 90 weighs just 14 lbs. that is under a weight limit for a box 90 of its size for a particular shipping rate formula.

FIGS. 9A through 9C are sequential top plan views of a box 90 showing how individual components can be packaged for shipping.

While the particular Modular Laundry Cart Having Collapsible Basket as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A laundry cart having a generally rectangular basket comprising:
left and right grated side panels;
a grated front panel removably secured the left and right grated side panels;
a grated rear panel removably secured the left and right grated side panels; and
a grated bottom panel removably secured to the grated front and rear panels, wherein the laundry cart can be assembled and disassembled for shipping.

2. The laundry cart of claim 1, wherein the grated front panel includes a top cross-bar, the top cross-bar optionally curved or straight, the curved front panel top cross-bar having a shape suitable for juxtaposition to a laundry dryer, the curved or straight front panel top cross-bars being modular and interchangeable with respect to previous and subsequent components fabricated in manufacturing.

3. The rectangular basket of claim 1, wherein the grated rear panel includes a top cross-bar, the grated rear panel top cross-bar optionally curved or straight, the curved 20 rear panel top cross-bar having a shape suitable for juxtaposition to a laundry dryer, the curved or straight rear panel top cross-bars being modular and interchangeable with respect to previous and subsequent components fabricated in manufacturing.

4. The laundry cart of claim 1, further comprising a plurality of pivotable wheels.

5. The laundry cart of claim 1, further comprising a lower shelf assembly removably secured underneath the basket.

6. A generally rectangular basket comprising:
left and right grated side panels, each of the two grated side panels having lateral sides, the lateral sides supported by front and rear stanchion bars;
a grated front panel having top and bottom cross-bars, the top and bottom cross-bars each removably secured the front left and right lateral side stanchion bars;
a grated rear panel having top and bottom cross-bars, the top and bottom cross-bars each removably secured the rear left and right lateral side stanchion bars; and
a grated bottom panel having a first bottom support bar removably secured to the front and rear bottom cross-bars, wherein the rectangular basket can be assembled and disassembled for shipping.

7. The rectangular basket of claim 6, wherein the grated front panel top cross-bar is optionally curved or straight, the curved front panel top cross-bar having a shape suitable for juxtaposition to a laundry dryer, the rectangular basket configured as a laundry basket, the curved or straight front panel top cross-bars being modular and interchangeable with respect to previous and subsequent components fabricated in manufacturing.

8. The rectangular basket of claim 6, wherein the grated rear panel top cross-bar is optionally curved or straight, the curved rear panel top cross-bar having a shape suitable for juxtaposition to a laundry dryer, the rectangular basket configured as a laundry basket, the curved or straight rear panel top cross-bars being modular and interchangeable with respect to previous and subsequent components fabricated in manufacturing.

9. The rectangular basket of claim 6, wherein the grated bottom panel further comprises a second bottom support bar removably secured to the front and rear panel bottom cross-bars.

10. The rectangular basket of claim 6 further comprising a wheel removably secured to a bottom of each of the left and right lateral side front and rear stanchion bars.

11. The rectangular basket of claim 6, further comprising a lower shelf assembly generally underneath the basket, the lower shelf assembly comprising:
a front horizontal cross-bar, removably connected the front left and right lateral side stanchion bars;
a rear horizontal cross-bar, removably connected the rear left and right lateral side stanchion bars;
a left lateral cross-bar, removably connected to the left front and left rear lateral side stanchion bars; and
a right lateral cross-bar, removably connected to the right front and right rear lateral side stanchion bars; and
a grated shelf supported by the front and rear horizontal cross-bars and the left and right lateral cross-bars.

12. The rectangular basket of claim 6, further comprising:
left and right posts removably secured to the left and right grated side panels, the left and right posts having an upper portion;
a lower horizontal cross-bar removably connected to the upper portion of the left and right posts; and
a highest horizontal cross-bar removably connected to the upper portion of the left and right post, the basket configured to be used as a laundry cart and the lower horizontal cross-bar configured to hang clothes therefrom.

13. The rectangular basket of claim 6, further comprising an upper hanger assembly, the upper hanger assembly comprising:
left and right posts removably secured to the left and right grated side panels, the left and right posts having removable upper and lower portions;
an arch assembly forming a highest horizontal cross-bar;
a lower horizontal cross-bar removably connected to the upper portion of the left and right posts.

14. A method of packaging a basket, the method comprising:
providing left and right grated side panels;
providing a grated front panel;
providing a grated rear panel;
providing a grated bottom panel;
stacking the left and right grated side panels, the grated front and rear panels and the grated bottom panel; and economically
packaging the left and right grated side panels, the grated front and rear panels and grated bottom panel to provide a relatively low package profile.

15. The method of packaging a basket of claim 14, wherein the basket is configured to be a laundry cart, the method further comprising:
providing a plurality of wheels; and economically
packaging the plurality of wheels with the left and right grated side panels, the grated front and rear panels and grated bottom panel to provide a relatively low profile package.

16. The method of packaging a basket of claim 14, wherein the low profile package has a volume and a density, and wherein low package profile is configured so that the volume is relatively low and the density is relatively high to economically package the basket.

17. The method of packaging a basket of claim 14, wherein the basket is configured to be a laundry cart, the method further comprising:
providing an upper hanger assembly wherein the upper hanger assembly is comprised of individual components; and economically
packaging the upper hanger assembly with the left and right grated side panels, and with the grated front and rear panels and grated bottom panel to provide a relatively low package profile.

18. The method of packaging a basket of claim 14, wherein the basket is configured to be a laundry cart, further comprising:
providing a lower shelf assembly comprised of individual components; and
economically packaging the a lower shelf assembly with the left and right grated side panels, and with the grated front and rear panels and grated bottom panel to provide a relatively low package profile.

19. A method of assembling a laundry cart having a basket comprising:
providing left and right grated side panels;
removably securing a grated front panel to the left and right grated side panels;
removably securing a grated rear panel to the left and right grated side panels; and
removably securing a bottom panel to the grated front and rear panels, wherein the laundry cart is able to be disassembled for shipping.

20. The method of assembling a laundry cart having a basket of claim 19, further comprising removably securing a plurality of pivotable wheels to the laundry cart.

21. The method of assembling a laundry cart having a basket of claim 19, further comprising removably securing a lower shelf assembly underneath the basket.
